(19) United States
(12) Patent Application Publication
(10) Pub. No.: US 2012/0165485 A1
(43) Pub. Date: Jun. 28, 2012

(54) Method for Control of the Degree of Branch of Polybutadiene with High 1,4-CIS Content

(76) Inventors: Hoo Chae Kim, Daejeon (KR); Seung Hwhon Lee, Daejeon (KR); Tae Hee Kim, Daejeon (KR)

(21) Appl. No.: 13/312,283

(22) Filed: Dec. 6, 2011

(30) Foreign Application Priority Data
Dec. 24, 2010 (KR) 10-2010-0134947

(51) Int. Cl. C08F 4/14

(52) U.S. Cl. 526/133

(57) ABSTRACT

A method for controlling the degree of branching of a 1,4-cis polybutadiene when preparing the 1,4-cis polybutadiene from 1,3-butadiene monomers in a nonpolar solvent using a catalyst system containing a an organonickel compound, alkylaluminum compound, and a boron fluoride complex is carried out by controlling the catalyst combination and a pretreatment condition. The method allows easy control of the degree of branching of the 1,4-cis polybutadiene without having to control the polymerization temperature or to add additional additives. As a result, the processability and the physical properties of the polymer can be optimized.

### CROSS-REFERENCE TO RELATED APPLICATIONS

This application claims priority under 35 U.S.C. §119 to Korean Patent Application No. 10-2010-0134947, filed on Dec. 24, 2010, in the Korean Intellectual Property Office, the disclosure of which is incorporated herein by reference in its entirety.

### STATEMENT REGARDING FEDERALLY SPONSORED RESEARCH OR DEVELOPMENT

Not Applicable

### BACKGROUND OF THE INVENTION

1. Technical Field

The present invention relates to a method for controlling the degree of branching of a polybutadiene with a high 1,4-cis content. More particularly, the present invention relates to a method for controlling the degree of branching when preparing a polybutadiene with a high 1,4-cis content by polymerizing 1,3-butadiene in the presence of a Ziegler-Natta catalyst.

2. Background Art

In general, the degree of branching is closely related with the processability and physical properties of a polymer, together with average molecular weight, molecular weight distribution, and the like. It can be calculated from the ratio of solution viscosity to Mooney viscosity. A polymer with a large solution viscosity/Mooney viscosity ratio has high linearity (low degree of branching), and a polymer with a smaller ratio has a higher degree of branching. In general, a polymer with a low degree of branching, i.e., one with a high linearity, has increased cold flow tendency, resulting in poor workability and causing difficulty in handling during packaging, transfer and storage. In contrast, a polymer with a high degree of branching provides good workability due to decreased cold flow tendency. But, physical properties are unsatisfactory.

Therefore, when manufacturing a tire, a rubber with a relatively high degree of branching and not so large a molecular weight may be suitable for the portion where processability is important, whereas a rubber with a low degree of branching and a large molecular weight may be adequate for the portion where good physical properties such as impact resistance or tensile strength are desired.

As an example of controlling the degree of branching of a polybutadiene with a high 1,4-cis content, European Patent No. 0093075 to Puccio discloses a method of preparing a 1,4-cis polybutadiene using a catalyst system of an organonickel compound, an organoaluminum compound, and a hydrogen fluoride compound, wherein the degree of branching of the 1,4-cis polybutadiene is controlled by varying the amount of the organonickel compound and the polymerization temperature.

U.S. Pat. Nos. 3,528,957 and 3,483,177, both to Throckmorton et al., disclose a method of preparing a 1,4-cis polybutadiene using a catalyst comprising an organonickel compound, an organoaluminum compound and a boron trifluoride complex, wherein the solution viscosity of the 1,4-cis polybutadiene is controlled by varying the catalyst and the amount thereof to improve processability and physical properties. These patents are based on the fact that, at a constant Mooney viscosity, the degree of branching decreases as the solution viscosity increases and, conversely, the degree of branching increases as the solution viscosity decreases.

As another example, U.S. Pat. No. 3,464,965 to Yasunaga et al. discloses a method of controlling the cold flow tendency of a 1,4-cis polybutadiene, which is closely related with processability and workability. The fact that the cold flow tendency decreases as the degree of branching of the 1,4-cis polybutadiene increases and, conversely, the cold flow tendency increases as the degree of branching decreases is utilized. Specifically, an organonickel compound, a boron trifluoride compound, and an organoaluminum compound are used as catalyst for polymerizing the polybutadiene, and the degree of branching of the 1,4-cis polybutadiene is controlled by varying the amount of a diene compound added to the organonickel compound prior to the polymerization.

Meanwhile, the solution viscosity and Mooney viscosity of the 1,4-cis polybutadiene is closely related with its molecular weight. In general, the larger the molecular weight of the 1,4-cis polybutadiene, the higher are the solution viscosity and the Mooney viscosity. Accordingly, many examples of improving the processability and physical properties of the 1,4-cis polybutadiene by controlling its molecular weight are known.

As a typical example, U.S. Pat. No. 5,100,982 to Castner discloses a method of controlling the molecular weight and molecular weight distribution of a 1,4-cis polybutadiene using a catalyst system containing an organonickel compound, an organoaluminum compound, and a boron trifluoride compound and using a halogenated phenol derivative as an additive.

U.S. Pat. No. 5,451,646 to Castner discloses a method for improving the processability of a 1,4-cis polybutadiene by controlling its molecular weight using a catalyst system containing an organonickel compound, an organoaluminum compound, and a fluorine containing compound and using para-styrenated diphenylamine.

As another example, Japanese Patent No. 78-51286 discloses a method of preparing a 1,4-cis polybutadiene with a narrow range of molecular weight distribution using a nickel compound, a boron compound, an alkyllithium, and an alkylbenzenesulfonate.

Korean Patent Application Publication No. 1999-0071124 to Jang et al., filed by the applicant of the present invention, discloses a method of controlling the degree of branching of a polybutadiene by changing the number of carbon atoms of the alkyl group of an alkylaluminum or an aluminoxane of a Ziegler-Natta catalyst and thus regulating the reactivity. Also, Korean Patent Application Publication No. 2002-0003481 to Jang et al. discloses a method of easily controlling the degree of branching of a 1,4-cis polybutadiene in polymerization using a catalyst system containing an organonickel compound, an organoaluminum compound, and a fluorine compound by using a dialkylzinc compound as a branching control agent and varying its addition amount.

In addition, U.S. Pat. No. 4,533,711 to Takeuchi et al. discloses a method of extending the molecular weight distribution, wherein a rare earth metal compound having an atomic•number from 57 to 71, an organoaluminum compound, and a halogenated aluminum compound are employed as a main catalyst and an organoaluminum hydride or a hydrocarbon compound containing activated hydrogen is used as a molecular weight control agent.

However, the existing methods of controlling the degree of branching and the molecular weight in preparing the 1,4-cis polybutadiene are problematic in that the polymerization yield and the 1,4-cis content are lowered or the process becomes complex for industrial production since further facilities are required due to the change in cocatalysts and use of additives. In addition, increased wastewater generation caused by use of additional reagents results in increased preparation cost.

Also, when the organonickel compound, the main catalyst of the Ziegler-Natta catalyst system, is mixed with the organoaluminum cocatalyst, the organonickel compound may be reduced during aging. This may lead to a decreased catalytic activity and result in remarkably decreased polymerization yield. Further, decreasing of polymerization temperature or monomer concentration in order to increase the linearity of the 1,4-cis polybutadiene as desired is limited in its effect, and, in this case, productivity may be decreased due to low polymerization yield.

### SUMMARY OF THE INVENTION

The inventors of the present invention have studied to solve the problems of increased cost, decreased productivity, and the like associated with the control of the degree of branching of a 1,4-cis polybutadiene. The present invention is directed to providing a method for controlling the degree of branching of a polybutadiene with a high 1,4-cis content by changing a catalyst combination and a pretreatment condition without changing of polymerization temperature or cocatalysts, addition of additives, decrease of monomer concentration, or the like, thus regulating the rate of reactive species formation, thereby greatly improving processability and physical properties of the rubber easily without sacrificing polymerization yield or productivity.

In one general aspect, the present invention provides a method for controlling the degree of branching of a 1,4-cis polybutadiene in preparing a 1,4-cis polybutadiene by polymerizing butadiene monomers in the presence of a catalyst system containing an organonickel compound, an aluminum compound, and a boron fluoride complex, including: sequentially adding the organonickel compound, the boron fluoride complex, and the aluminum compound to a polymerization reactor without aging; or adding one of the organonickel compound, the boron fluoride complex, and the aluminum compound to a polymerization reactor without aging and adding the other two to the polymerization reactor after aging at −20 to 60° C.

The above and other aspects and features of the present invention will be described infra.

### BRIEF DESCRIPTION OF THE DRAWING

FIG. 1 is a graph showing a result according to the invention of determining the degree of branching of 1,4-cis polybutadienes prepared in Examples 1-4 and Comparative Examples 6 and 10 according to the Mark-Houwink equation.

### DETAILED DESCRIPTION OF THE INVENTION

Hereinafter, reference will now be made in detail to various embodiments of the present invention, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

The present invention provides a method for controlling the degree of branching of a 1,4-cis polybutadiene in preparing a 1,4-cis polybutadiene by polymerizing butadiene monomers in the presence of a Ziegler-Natta catalyst system of an organonickel compound, an aluminum compound, and a boron fluoride complex, comprising: sequentially adding the organonickel compound, the boron fluoride complex, and the aluminum compound to a polymerization reactor without aging; or adding one of the organonickel compound, the boron fluoride complex, and the aluminum compound to a polymerization reactor without aging and adding the other two to the polymerization reactor after aging at −20 to 60° C.

In the present invention, the catalyst may comprise the organonickel compound, the aluminum compound, and the boron fluoride complex at a molar ratio of 1:1-20:0.7-50. For the aging, the organoaluminum compound and the organonickel compound may be mixed at a molar ratio of 1:1 to 20:1, the boron fluoride complex and the organoaluminum compound mixed at a molar ratio of 0.7:1 to 20:1, and the boron fluoride complex and the organonickel compound mixed at a molar ratio of 1:1 to 30:1.

The organonickel compound may be a carboxylic compound or a phenolimine derivative having good solubility in a nonpolar solvent. Specific examples include nickel hexanoate, nickel heptanoate, nickel octanoate, nickel 2-ethylhexanoate, nickel naphthenate, nickel versatate, nickel 1,2-cyclohexanediamino-N,N′-bis(3,54-butylsalicylidene), nickel hexamethylacetylacetonate, and nickel stearate, but are not limited thereto.

The aluminum compound may be a compound represented by the formula

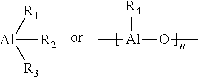

(wherein each of R₁-R₄ is C₁-C₁₀ alkyl, cycloalkyl, aryl, arylalkyl, alkoxy or hydrogen). Specific examples include trimethylaluminum, triethylaluminum, tripropylaluminum, tributylaluminum, triisobutylaluminum, trihexylaluminum, trioctylaluminum, and diisobutylaluminum hydride, but are not limited thereto.

The boron fluoride complex may be a complex of boron trifluoride (BF₃) with one or more selected from the group consisting of an ether compound, a ketone compound, and an ester compound. The ether compound may be selected from dimethyl ether, diethyl ether, dibutyl ether, tetrahydrofuran, dihexyl ether, dioctyl ether, and methyl t-butyl ether, the ketone compound may be selected from acetone, methyl ethyl ketone, cyclohexanone, methyl isoamyl ketone, and 2-heptanone, and the ester compound may be selected from methyl acetate, ethyl acetate, butyl acetate, methyl pyruvate, ethyl pyruvate, methyl methoxypropionate, and ethyl ethoxypropionate, but are not limited thereto.

In the present invention, a solvent used in the polymerization may be one or more selected from the group consisting of a C₄-C₁₀ aliphatic hydrocarbon, a C₅-C₁₀ cyclic aliphatic hydrocarbon, and a C₆-C₁₀ aromatic hydrocarbon. Specific examples of the C₄-C₁₀ aliphatic hydrocarbon include butane, pentane, hexane, heptanes, and octane, specific examples of the C₅-C₁₀ cyclic aliphatic hydrocarbon include cyclopentane, cyclohexane, cycloheptane, and cyclooctane, and specific examples of the C₆-C₁₀ aromatic hydrocarbon include benzene, toluene, and xylene, but are not limited thereto.

In the present invention, the organonickel compound, the boron fluoride complex, and the aluminum compound may be sequentially added to the polymerization reactor, or a combination of two of these may be aged in advance in an aging reactor by stirring at a predetermined temperature for a predetermined time and then the resulting mixture may be added to the polymerization reactor.

The aging of the catalyst may be performed by pretreating in a catalyst aging solvent at −20 to 60° C. for 5 minutes to 2 hours.

The catalyst aging solvent should be a nonpolar solvent that does not react with the catalyst components, and may be selected from cyclohexane, hexane, heptane, toluene, etc.

The polymerization may be performed at 20-100° C. for 1 to 10 hours. As a result of the polymerization, polybutadiene may be prepared at a yield of 85% or better.

After the reaction is completed, addition of a reaction terminator such as polyoxyethylene glycol ether organophosphate; 2,6-di-t-butyl-p-cresol, etc. followed by precipitation in a solvent such as methyl alcohol, ethyl alcohol, etc., yields the product.

The degree of branching of the resulting 1,4-cis polybutadiene may be determined from the ratio of the solution viscosity (SV) and the Mooney viscosity (MV), i.e., SV/MV. The solution viscosity may be measured at 25° C. using an Ubbelohde viscometer, and the Mooney viscosity may be measured using a Mooney viscometer (Model No. SMV-201, Shimadzu Co., Ltd). A Mark-Houwink plot may be obtained by measuring the absolute molecular weight based on light scattering by GPC and measuring the intrinsic viscosity using a viscometer (Model No. TDA-302, ViscoTec).

The 1,4-cis polybutadiene prepared in accordance with the present invention may be controlled to have a weight average molecular weight of approximately 100000 to 500000, and has a high degree of branching with the ratio of solution viscosity (cps)/Mooney viscosity (M₁₊₄, 100° C.) being 7-13.

### EXAMPLES

The examples and experiments will now be described. The following examples and experiments are for illustrative purposes only and not intended to limit the scope of this disclosure.

### Example 1

The Ziegler-Natta catalyst used in the reaction was prepared by mixing nickel naphthenate (0.05% toluene solution), boron trifluoride diethyl ether (1.5% toluene solution), and triethylaluminum (0.8% toluene solution) in the absence or presence of a small quantity of 1,3-butadiene. The nickel catalyst was used in an amount of 6.81×10⁻⁵ mol based on 100 g of monomers.

Then, a polybutadiene with a high 1,4-cis content was prepared by, after sufficiently purging a 360-mL pressurized reactor with nitrogen, adding the monomer 1,3-butadiene to a polymerization solvent comprising cyclohexane, heptanes, and toluene at 8:1:1 based on weight, and then sequentially adding the nickel naphthenate, the triethylaluminum, and the boron trifluoride diethyl ether to the polymerization reactor without aging pretreatment.

The ratio of the amount of the polymerization solvent to the monomer was 5. When the reaction was completed, 2,6-di-t-butylylene glycol, polyoxyethylene glycol phosphate, and ethanol were added to terminate the reaction.

Physical properties of the resulting polybutadiene are given in Table 1 below.

### Example 2

A polybutadiene with a high 1,4-cis content was prepared in the same manner as in Example 1, except for changing the addition amount of the catalyst components as described in Table 1 with the same catalyst combination. Physical properties of the resulting polybutadiene are given in Table 1.

### Example 3

A polybutadiene with a high 1,4-cis content was prepared in the same manner as in Example 1, except for aging the triethylaluminum and the boron trifluoride diethyl ether in a catalyst aging reactor at 20° C. for 1 hour and then adding to the polymerization reactor together with the nickel naphthenate. Physical properties of the resulting polybutadiene are given in Table 1.

### Example 4

A polybutadiene with a high 1,4-cis content was prepared in the same manner as in Example 1, except for changing the addition amount of the catalyst components as described in Table 1, under the same aging condition as in Example 3. Physical properties of the resulting polybutadiene are given in Table 1.

### Example 5

A polybutadiene with a high 1,4-cis content was prepared in the same manner as in Example 1, except for aging the nickel naphthenate and the boron trifluoride diethyl ether in a catalyst aging reactor at 20° C. for 1 hour and then adding to the polymerization reactor together with the triethylaluminum. Physical properties of the resulting polybutadiene are given in Table 1.

### Example 6

A polybutadiene with a high 1,4-cis content was prepared in the same manner as in Example 1, except for aging the triethylaluminum and the nickel naphthenate in a catalyst aging reactor at 20° C. for 1 hour and then adding to the polymerization reactor together with the boron trifluoride diethyl ether. Physical properties of the resulting polybutadiene are given in Table 1.

TABLE 1

| | | | Molar ratio | Solution | | Mooney | |
|---|---|---|---|---|---|---|---|
| | | | of catalyst | viscosity/ | Solution | viscosity | |
| | Catalyst | Aging | components | Mooney | viscosity | (M₁₊₄, | Yield |
| | combination* | condition | (Ni:BF3:TEA) | viscosity | (cps) | 100° C.) | (%) |
| Ex. 1 | Ni, TEA, BF3 | not aged | 1:12:9 | 12.9 | 593 | 46 | 92 |
| Ex. 2 | Ni, TEA, BF3 | not aged | 1.1:13:10 | 12.1 | 375 | 31 | 94 |
| Ex. 3 | Ni, | Ni: not aged | 1:12:9 | 9.50 | 361 | 38 | 90 |
| | (TEA + BF3) | TEA + BF3: | | | | | |
| | | aged for 1 hr | | | | | |
| Ex. 4 | Ni, | Ni: not aged | 1.1:13:10 | 9.29 | 325 | 35 | 91 |
| | (TEA + BF3) | TEA + BF3: | | | | | |
| | | aged for 1 hr | | | | | |
| Ex. 5 | TEA, | TEA: not aged | 1:12:9 | 11.3 | 508 | 45 | 92 |
| | (Ni + BF3) | Ni + BF3: | | | | | |
| | | aged for 1 hr | | | | | |
| Ex. 6 | BF3, | BF3: not aged | 1:12:9 | 7.9 | 316 | 40 | 89 |
| | (TEA + Ni) | TEA + Ni: | | | | | |
| | | aged for 1 hr | | | | | |

*Ni = nickel naphthenate, TEA = triethylaluminum, BF3 = boron trifluoride diethyl ether

As seen in Table 1, the ratio of solution viscosity/Mooney viscosity was largest when the catalyst components were added to the polymerization reactor without aging, as in Examples 1 and 2. This suggests that a more linear polymer was prepared as the formation rate of the catalytic active species was reduced. The results (the ratio of solution viscosity/Mooney viscosity) for Examples 3-6 reveal that the degree of branching of the polymer could be increased when the boron trifluoride compound and the aluminum compound were aged, and further increased when the nickel compound and the aluminum compound were aged.

### Comparative Example 1-3

A polybutadiene with a high 1,4-cis content was prepared in the same manner as in Example 1, except for changing the reaction temperature as described in Table 2 below.

The reaction catalyst was aged as follows. To a 100-mL round-bottom flask sealed with a rubber stopper after sufficiently purging with nitrogen, nickel naphthenate, boron trifluoride diethyl ether, and triethylaluminum were sequentially added at a molar ratio 1:12:9 to the catalyst aging reactor, which were then aged at 20° C. for 1 hour. Physical properties of the resulting polybutadiene are given in Table 2.

TABLE 2

| | | Solution | | Mooney | |
|---|---|---|---|---|---|
| | Reaction | viscosity/ | Solution | viscosity | |
| | temperature | Mooney | viscosity | (M₁₊₄, | Yield |
| | (° C.) | viscosity | (cps) | 100° C.) | (%) |
| Comp. | 50 | 3.02 | 130 | 43 | 82 |
| Ex. 1 | | | | | |
| Comp. | 60 | 3.00 | 126 | 42 | 85 |
| Ex. 2 | | | | | |
| Comp. | 70 | 3.62 | 152 | 42 | 90 |
| Ex. 3 | | | | | |

### Comparative Example 4-6

A polybutadiene with a high 1,4-cis content was prepared in the same manner as in Example 1, except for changing the reaction time as described in Table 3 below.

The reaction catalyst was aged as follows. To a 100-mL round-bottom flask sealed with a rubber stopper after sufficiently purging with nitrogen, nickel naphthenate, boron trifluoride diethyl ether, and triethylaluminum were sequentially added at a molar ratio 1:12:9 to the catalyst aging reactor, which were then aged at 20° C. for 1 hour. Physical properties of the resulting polybutadiene are given in Table 3.

TABLE 3

| | | Solution | | Mooney | |
|---|---|---|---|---|---|
| | Reaction | viscosity/ | Solution | viscosity | |
| | time | Mooney | viscosity | (M₁₊₄, | Yield |
| | (min) | viscosity | (cps) | 100° C.) | (%) |
| Comp. | 60 | 2.88 | 118 | 41 | 87 |
| Ex. 4 | | | | | |
| Comp. | 90 | 2.63 | 105 | 40 | 85 |
| Ex. 5 | | | | | |
| Comp. | 120 | 3.09 | 136 | 44 | 85 |
| Ex. 6 | | | | | |

### Comparative Example 7-11

A polybutadiene with a high 1,4-cis content was prepared in the same manner as in Example 1, except for changing the addition amount of the aluminum compound as described in Table 4 below.

The reaction catalyst was aged as follows. To a 100-mL round-bottom flask sealed with a rubber stopper after sufficiently purging with nitrogen, nickel naphthenate, boron trifluoride diethyl ether, and triethylaluminum were sequentially added at a molar ratio 1:12:9 to the catalyst aging reactor, which were then aged at 20° C. for 1 hour. Physical properties of the resulting polybutadiene are given in Table 4.

TABLE 4

| | Molar ratio | Solution | | Mooney | |
|---|---|---|---|---|---|
| | of catalyst | viscosity/ | Solution | viscosity | |
| | components | Mooney | viscosity | (M₁₊₄, | Yield |
| | (Ni:BF3:TEA) | viscosity | (cps) | 100° C.) | (%) |
| Comp. | 1:12:4 | 2.83 | 103 | 36 | 84 |
| Ex. 7 | | | | | |
| Comp. | 1:12:6 | 2.97 | 104 | 35 | 90 |
| Ex. 8 | | | | | |
| Comp. | 1:12:8 | 3.46 | 152 | 44 | 87 |
| Ex. 9 | | | | | |
| Comp. | 1:12:9 | 4.53 | 213 | 47 | 84 |
| Ex. 10 | | | | | |
| Comp. | 1:12:10 | 4.72 | 259 | 55 | 80 |
| Ex. 11 | | | | | |

### Test Example 1

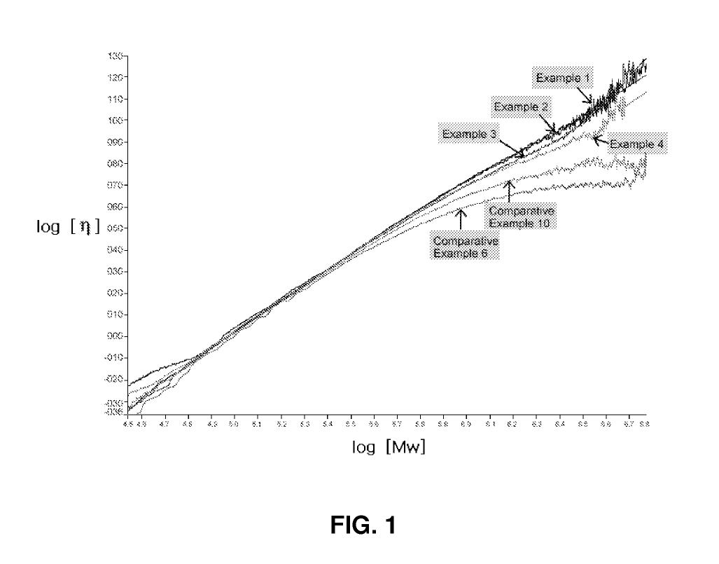

In order to determine the degree of branching of the 1,4-cis polybutadienes prepared in Examples 1-4 and Comparative Examples 6 and 10, the polybutadiene was dissolved in tetrahydrofuran to prepare a 1 mg/mL dilute solution. After measuring absolute molecular weight (M_{w}) and intrinsic viscosity (η) based on light scattering using a GPC equipped with a viscometer, a Mark-Houwink plot was obtained by taking logarithm of the following Mark-Houwink equation. The result is shown in FIG. 1 (see Rubber and Plastics Age, 1965, p. 821, Hoff, B. M. E.; Henderson, J. F.; Small, R. M. B.).

[η]=KM_{w}^{a}

In the Mark-Houwink plot, a larger slope means a polymer with a lower degree of branching, i.e., a more linear polymer. Conversely, a smaller slope is interpreted as a higher degree of branching. The degree of branching confirmed by the Mark-Houwink plot coincides with that obtained from the ratio of solution viscosity/Mooney viscosity given in Tables 1-4.

### Test Example 2

In order to measure the physical properties of the 1,4-cis polybutadienes prepared in Examples 1 and 3 and Comparative Examples 6 and 10, the components listed in Table 5 (below) were mixed, and then blending processability and physical properties after the blending were compared. The result is given in Table 6 below.

TABLE 5

| | | Blending |
|---|---|---|
| | Components | composition (g) |
| Master batch mixing | 1,4-Polybutadiene | 208.33 |
| | Zinc oxide (ZnO) | 6.25 |
| | Stearic acid | 4.17 |
| | Carbon black | 125 |
| | ASTM type 103 petroleum oil | 31.25 |
| Total | | 375 |
| Final mixing | Sulfur | 3.13 |
| | TBBS* | 1.88 |

| | |
|---|---|
| Grand total | 380 |

*TBBS: N-tert-butyl-2-benzothiazylsulfonamide

TABLE 6

| | | | Comp. | Comp. |
|---|---|---|---|---|
| | Ex. 1 | Ex. 3 | Ex. 6 | Ex. 10 |
| Mooney viscosity (ML₁₊₄, 100° C.) | 46 | 38 | 44 | 47 |
| Solution viscosity | 593 | 361 | 136 | 213 |
| Solution viscosity/Mooney viscosity | 12.9 | 9.50 | 3.09 | 4.53 |
| Cis content (wt %) | 97.5 | 97.1 | 97.3 | 97.6 |
| Compound Mooney viscosity | 68 | 61 | 54 | 57 |
| (ML₁₊₄, 100° C.) | | | | |
| Tensile strength (kgf/cm²) | 210 | 205 | 186 | 203 |
| Elongation (%) | 560 | 520 | 540 | 560 |
| 300% modulus (kgf/cm²) | 103 | 100 | 96 | 92 |

As seen from Table 6, when the catalyst combination and the pretreatment condition were changed when polymerizing the 1,4-polybutadiene using the organonickel compound, the boron trifluoride compound, and the organoaluminum compound, the degree of branching of the polybutadiene could be controlled easily without affecting the 1,4-cis content, without having to change the polymerization temperature and time, the catalyst composition, or the like. Thus, the processability and the physical properties of the rubber can be optimized.

When the catalyst combination and the pretreatment condition are changed to polymerize a high 1,4-cis polybutadiene using the organonickel compound, the boron trifluoride compound, and the organoaluminum compound in accordance with the present invention, the degree of branching of the polybutadiene can be controlled easily without having to control the polymerization temperature or to add additional additives. As a result, the processability and the physical properties of the rubber can be optimized.

The present invention has been described in detail with reference to specific embodiments thereof. However, it will be appreciated by those skilled in the art that various changes and modifications may be made in these embodiments without departing from the principles and spirit of the disclosure, the scope of which is defined in the appended claims and their equivalents.

1. A method for controlling a degree of branching of a 1,4-cis polybutadiene in preparing a 1,4-cis polybutadiene by polymerizing butadiene monomers in the presence of a catalyst system of an organonickel compound, an aluminum compound and a boron fluoride complex, comprising:
sequentially adding the organonickel compound, the boron fluoride complex, and the aluminum compound to a polymerization reactor without aging; or adding one of the organonickel compound, the boron fluoride complex, and the aluminum compound to a polymerization reactor without aging and adding the other two to the polymerization reactor after aging at −20 to 60° C.

2. The method for controlling the degree of branching of a 1,4-cis polybutadiene according to claim 1, wherein a molar ratio of the organonickel compound, the aluminum compound, and the boron fluoride complex is 1:1-20:0.7-50.

3. The method for controlling the degree of branching of a 1,4-cis polybutadiene according to claim 1, wherein the organonickel compound is one or more selected from the group consisting of nickel hexanoate, nickel heptanoate, nickel octanoate, nickel 2-ethylhexanoate, nickel naphthenate, nickel versatate, nickel 1,2-cyclohexanediamino-N,N′-bis(3,5-t-butylsalicylidene), nickel hexamethylacetylacetonate, and nickel stearate.

4. The method for controlling the degree of branching of a 1,4-cis polybutadiene according to claim 1, wherein the aluminum compound is one or more selected from the group consisting of trimethylaluminum, triethylaluminum, tripropylaluminum, tributylaluminum, triisobutylaluminum, trihexylaluminum, trioctylaluminum, and diisobutylaluminum hydride.

5. The method for controlling the degree of branching of a 1,4-cis polybutadiene according to claim 1, wherein the boron fluoride complex is a complex of boron trifluoride (BF₃) with one or more selected from the group consisting of an ether compound, a ketone compound, and an ester compound.

6. The method for controlling the degree of branching of a 1,4-cis polybutadiene according to claim 5, wherein:
the ether compound is selected from dimethyl ether, diethyl ether, dibutyl ether, tetrahydrofuran, dihexyl ether, dioctyl ether, and methyl t-butyl ether;
the ketone compound is one or more selected from the group consisting of acetone, methyl ethyl ketone, cyclohexanone, methyl isoamyl ketone, and 2-heptanone; and
the ester compound is selected from methyl acetate, ethyl acetate, butyl acetate, methyl pyruvate, ethyl pyruvate, methyl methoxypropionate and ethyl ethoxypropionate.

7. The method for controlling the degree of branching of a 1,4-cis polybutadiene according to claim 1, wherein, in the polymerization, one or more selected from the group consisting of a C₄-C₁₀ aliphatic hydrocarbon, a C₅-C₁₀ cyclic aliphatic hydrocarbon, and a C₆-C₁₀ aromatic hydrocarbon is used as a solvent.

8. The method for controlling the degree of branching of a 1,4-cis polybutadiene according to claim 7, wherein:
the C₄-C₁₀ aliphatic hydrocarbon is selected from butane, pentane, hexane, heptanes, and octane;
the C5-C10 cyclic aliphatic hydrocarbon is one or more selected from the group consisting of cyclopentane, cyclohexane, cycloheptane, and cyclooctane; and
the C₆-C₁₀ aromatic hydrocarbon is selected from benzene, toluene and xylene.

9. The method for controlling the degree of branching of a 1,4-cis polybutadiene according to claim 1, wherein the aging of the catalyst is performed by pretreating in a catalyst aging solvent at −20 to 60° C. for 5 minutes to 2 hours.

10. The method for controlling the degree of branching of a 1,4-cis polybutadiene according to claim 9, wherein the catalyst aging solvent is one of cyclohexane, hexane, heptanes, and toluene.

11. The method for controlling the degree of branching of a 1,4-cis polybutadiene according to claim 1, wherein the polymerization is performed at 20-100° C. for 1-12 hours.

12. The method for controlling the degree of branching of a 1,4-cis polybutadiene according to claim 1, wherein the degree of branching calculated from the ratio of solution viscosity (cps)/Mooney viscosity (M₁₊₄, 100° C.) is 7-13.

13. A method for controlling a degree of branching of a 1,4-cis polybutadiene, comprising:
in preparing a 1,4-cis polybutadiene by polymerizing butadiene monomers in the presence of a catalyst system of an organonickel compound, an aluminum compound and a boron fluoride complex, one of:
sequentially adding the organonickel compound, the boron fluoride complex, and the aluminum compound to a polymerization reactor without aging; and
adding one of the organonickel compound, the boron fluoride complex, and the aluminum compound to a polymerization reactor without aging and adding the other two to the polymerization reactor after aging at −20 to 60° C.
